(19) United States
(12) Patent Application Publication
(10) Pub. No.: US 2019/0076889 A1
(43) Pub. Date: Mar. 14, 2019

(54) Automatically clean and dry device via ultrasonic vacuum for intelligent household umbrellas

(71) Applicant: Ting Chiu Cheng, Hong Kong (HK)

(72) Inventor: Ting Chiu Cheng, Hong Kong (HK)

(21) Appl. No.: 15/730,721

(22) Filed: Oct. 11, 2017

(30) Foreign Application Priority Data
Sep. 11, 2017 (CN) 201721160385.3

(51) Int. Cl. B08B 7/02; B08B 1/00; B08B 15/00

(52) U.S. Cl. CPC B08B 7/028; B08B 15/00; B08B 1/003

(57) ABSTRACT

The invention relates to an automatically clean and dry device via ultrasonic vacuum for intelligent household umbrellas which includes a sleeve, a folding bracket, a sliding plate, and a rainwater collector. The sleeve includes an upper sleeve, a middle sleeve, a telescopic sleeve and a lower sleeve. The upper sleeve and the middle sleeve are sleeved, and are engaged with each other. An annular box and an umbrella cover are provided on the upper sleeve. The inside wall of the middle sleeve is provided with ultrasonic transducers and fiber brushes. The telescopic sleeve includes a first corrugated telescopic tube, connecting flanges, a reset spring, and a water-absorbing mechanism. The lower end of the lower sleeve is provided with a cushion mechanism. A T-shaped chute is provided on the sliding plate. The rainwater collector connects to the sliding plate by the support plate. The automatically clean and dry device via ultrasonic vacuum for intelligent household umbrellas of the invention has advantages of having reasonable and simple structure, and various functions, being easy to use, safe and reliable, and not being easily damaged, etc. It effectively solves the problem regarding the fact that the existing dry devices for umbrellas easily damage the umbrellas.

### FIELD OF THE INVENTION

The invention relates to intelligent household appliances. In particular, the invention relates to an automatically clean and dry device via ultrasonic vacuum for intelligent household umbrellas.

### BACKGROUND

In the know technology, an umbrella includes ribs and a waterproof cloth that covers the ribs. Part of the ribs include a folding mechanism to reduce the volume of the umbrella. Umbrellas bring a lot of convenience to people's life; however, how to put way umbrellas after use is a problem. On one hand, rainwater falls from the umbrella to the ground, which causes the ground to be slippery. The slippery ground is dangerous to especially the elder and children. On another hand, rainwater corrodes the umbrella. Unfolding the umbrella to dry it occupies large room.

As for mechanical methods, drying, spinning, or their combination are common methods to remove the rainwater from the surface of the umbrella. However, the waterproof cloth of the existing umbrellas is generally made of combustible and deformable material such as chemical fiber. Drying may damage the waterproof cloth. And the ribs are easily to be deformed, falling off and damaged during the rotation. Although the common mechanical methods can remove rainwater from umbrellas, the methods would easily damage the umbrellas. Moreover, the methods do not clean the umbrellas. Therefore, it is desired to develop an automatically clean and dry device via ultrasonic vacuum for intelligent household umbrellas.

### SUMMARY OF THE INVENTION

The technical problem to be solved is to overcome the above-mentioned deficiency by providing an automatically clean and dry device via ultrasonic vacuum for intelligent household umbrellas. The umbrella of the invention has advantages of having reasonable and simple structure, various functions, being easy to use, safe and reliable, not easily to be damaged, etc. It effectively solves the problem regarding the fact that the existing umbrella drying devices tend to damage the umbrellas.

The technical solution of the invention is to provide an automatically clean and dry device via ultrasonic vacuum for intelligent household umbrellas which includes a sleeve, a folding bracket, a sliding plate, and a rainwater collector. The sleeve includes an upper sleeve, a middle sleeve, a telescopic sleeve and a lower sleeve.

The upper sleeve and the middle sleeve are sleeved, and are engaged with each other at the sleeve place. The outside wall of the upper end of the upper sleeve is provided with an annular box and an umbrella cover. The umbrella cover is folded into an annular shape and sleeved into the annular box. The upper end of the umbrella cover is sleeved at the opening of the upper end of the upper sleeve. The inside wall of the middle sleeve is provided with an annular array consisting of a plurality of ultrasonic transducers. The ultrasonic transducers are provided with fiber brushes.

The telescopic sleeve includes a first corrugated telescopic tube, connecting flanges positioned at two ends of the first corrugated telescopic tube, and a reset spring positioned at the first corrugated telescopic tube. The connecting flanges positioned at two ends of the first corrugated telescopic tube connect to the middle sleeve and the lower sleeve, respectively. Two ends of the reset spring respectively connect to the connecting flanges at two ends of the first corrugated telescopic tube.

The top connecting flange is provided with a water-absorbing mechanism. The water-absorbing mechanism includes a water-absorbing sleeve that extends to the openings of two ends of the inside of the first corrugated telescopic tube, a plurality of cam shafts circumferentially arranged in the inside wall of the water-absorbing sleeve, a plurality of spindles, a sponge arranged at the spindles and having a concave curved structure, a connecting element that connects the spindle and the cam shaft. The connecting ends of the spindle and the cam shaft respectively extend into an inner cavity positioned at the connecting element, and are in contact with a third cushion spring in the inner cavity.

The lower end of the lower sleeve is provided with a cushion mechanism. The upper end of the lower sleeve is provided with a screen. A deflector used to guide rainwater towards a water outlet is positioned inside the lower sleeve.

The folding bracket includes a fixed bracket connected to the externals, and a movable bracket hinged to the fixed bracket. The movable bracket connects to the middle sleeve.

The sliding plate is fixed with the externals. The sliding plate is provided with a T-shaped chute. The T-shaped chute is provided with two second cushion springs. Two ends of the T-shaped chute are provided with blocks.

The rain collector includes a support plate slidably connected with the T-shaped chute, a vacuum pump positioned on the support plate, and a water box connected with the vacuum pump. The vacuum pump connects the water outlet via a second corrugated telescopic tube.

In a further example embodiment, the upper end of the upper sleeve is provided with outward revers. The inside of the upper end of the upper sleeve is provided with an infrared switch.

In a further example embodiment, the upper end of the umbrella cover is provided with an elastic belt. The elastic belt at the upper end of the below umbrella cover in the annular box is engaged with the middle portion of the above umbrella cover. The above umbrella cover and the below umbrella cover are folded together.

In a further example embodiment, the cushion mechanism includes a cushion sleeve positioned at the lower sleeve, a first cushion spring positioned in the cushion sleeve, and a cushion column extending into the cushion sleeve and being in contact with the first cushion spring.

In a further example embodiment, the movable bracket has a projection that is integrated with the movable bracket. The projection is in contact with the fixed bracket.

In a further example embodiment, the housing covers the vacuum pump and the water box, and connects with the support plate.

In a further example embodiment, a micro controller is positioned below the folding bracket. The micro controller is electrically connected to the infrared switch and the ultrasonic transducers.

In a further example embodiment, a press type switch used to control the vacuum pump is positioned above the housing. Two ends of the press type switch are electrically connected to the vacuum pump and the micro controller, respectively. The press type switch and the cushion column are positioned on the same shaft.

The technical effect of the invention is an automatically clean and dry device via ultrasonic vacuum for intelligent household umbrellas which includes a sleeve, a folding bracket, a sliding plate, and a rainwater collector. Two ends of the folding bracket connect to the sleeve and a fixed surface of the externals, respectively. The sleeve can be folded to save room when the sleeve is not used. Two ends of the sliding plate connect to the rainwater collector and a connecting surface of the externals, respectively. The rainwater collector can slide along the sliding plate to adapt to the length of the umbrella. By the combination of the ultrasonic wave and the brushes, the sleeve can shake off the rainwater from the umbrella and on other hand, the vibrated brushes clean the surface of the umbrella. The rainwater falls downstream and goes through the water-accumulating mechanism adapted to the diameter of the umbrella and the vacuum pump, such that the rainwater is collected into the water box. When the umbrella is pulled out, the umbrella cover on the sleeve automatically covers the umbrella. The device of the invention has advantages of having reasonable and simple structure, and various functions, being easy to use, safe and reliable, and not being easily damaged, etc. It effectively solves the problem regarding the fact that the existing dry devices for umbrellas easily damage the umbrellas.

### BRIEF DESCRIPTION OF THE DRAWINGS

The invention is illustrated by the following figures and embodiments.

FIG. 1 shows a schematic diagram of whole structure of an automatically clean and dry device via ultrasonic vacuum for intelligent household umbrellas.

FIG. 2 shows a cross sectional view of the connection of an upper sleeve and a middle sleeve of the automatically clean and dry device via ultrasonic vacuum for intelligent household umbrellas.

FIG. 3 shows a top view of the middle sleeve of the automatically clean and dry device via ultrasonic vacuum for intelligent household umbrellas.

FIG. 4 shows a top view of the upper sleeve of the automatically clean and dry device via ultrasonic vacuum for intelligent household umbrellas.

FIG. 5 shows a schematic diagram of an annular box, an umbrella cover and the upper sleeve of the automatically clean and dry device via ultrasonic vacuum for intelligent household umbrellas.

FIG. 6 shows a cross sectional view of a telescopic sleeve of the automatically clean and dry device via ultrasonic vacuum for intelligent household umbrellas.

FIG. 7 shows a schematic diagram of a water-absorbing mechanism of the automatically clean and dry device via ultrasonic vacuum for intelligent household umbrellas.

FIG. 8 shows a schematic diagram of a connecting element of the automatically clean and dry device via ultrasonic vacuum for intelligent household umbrellas.

FIG. 9 shows a schematic diagram of a lower sleeve of the automatically clean and dry device via ultrasonic vacuum for intelligent household umbrellas.

FIG. 10 shows a schematic diagram of a folding bracket of the automatically clean and dry device via ultrasonic vacuum for intelligent household umbrellas.

FIG. 11 shows a side view of a sliding plate of the automatically clean and dry device via ultrasonic vacuum for intelligent household umbrellas.

FIG. 12 shows a front view of a sliding plate of the automatically clean and dry device via ultrasonic vacuum for intelligent household umbrellas.

The reference numbers of the figures are as follows:

1: sleeve; 11: upper sleeve; 111: annular box; 112; umbrella cover; 113: elastic belt; 12: middle sleeve; 121: ultrasonic transducer; 122: brush; 123: micro controller; 13: telescopic sleeve; 131: first corrugated telescopic tube; 132: connecting flange; 133: reset spring; 134: water-absorbing mechanism; 1341: water-absorbing sleeve; 1342: cam shaft; 1343: connecting element; 1344: spindle; 1345: sponge; 1346: inner cavity; 1347: third cushion spring; 14: lower sleeve; 141: cushion mechanism; 1411: cushion sleeve; 1412: cushion column; 1413: first cushion spring; 142: screen; 143: deflector; 144: water outlet; 145: second corrugated telescopic tube; 2: folding bracket; 21: fixed bracket; 22: movable bracket; 23: projection; 3: sliding plate; 31: T-shaped chute; 32: block; 33: second cushion spring; 4: rainwater collector; 41: support plate; 42: vacuum pump; 43: water box; 44: press type switch; 45: housing.

### DETAILED DESCRIPTION

The invention is illustrated in accordance with figures. The figures as simplified diagrams demonstrate the basic structures of the apparatus of embodiments of the invention. Thus, the invention is not limited to the figures.

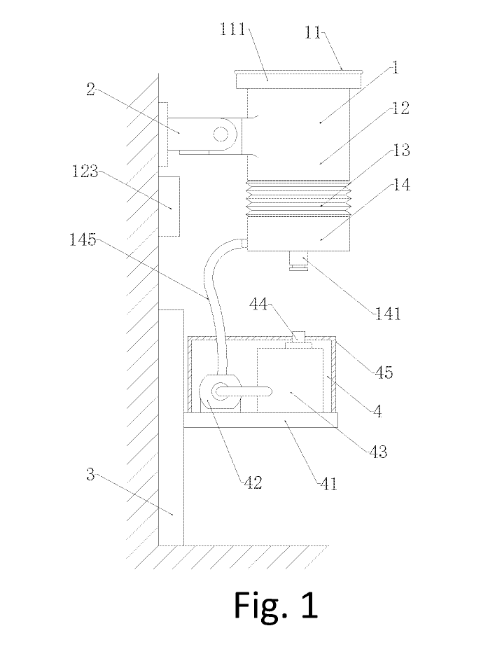

As shown in FIG. 1, an automatically clean and dry device via ultrasonic vacuum for intelligent household umbrellas includes a sleeve 1, a folding bracket 2, a sliding plate 3, and a rainwater collector 4. The sleeve 1 includes an upper sleeve 11, a middle sleeve 12, a telescopic sleeve 13 and a lower sleeve 14 from the top to the bottom. The upper sleeve 11, the middle sleeve 12, and the telescopic sleeve 13 have openings at two ends.

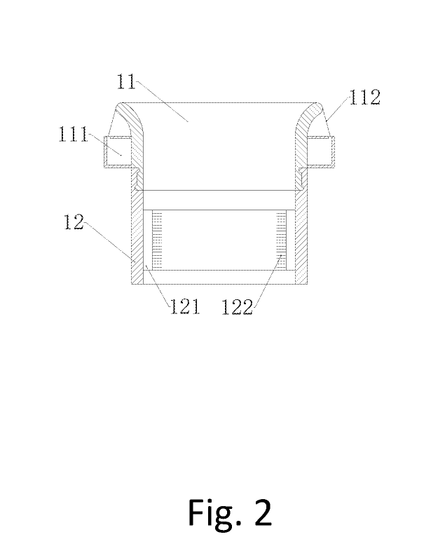

As shown in FIG. 2, the upper sleeve 11 and the middle sleeve 12 are sleeved, and are engaged with each other at the sleeve place. In another example embodiment, a connecting flange is provided to the connection place between the upper sleeve 11 and the middle sleeve 12. The upper sleeve 11 and the middle sleeve 12 are connected by the connecting flange.

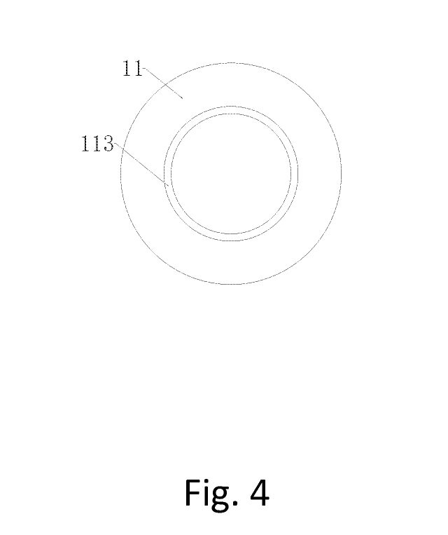

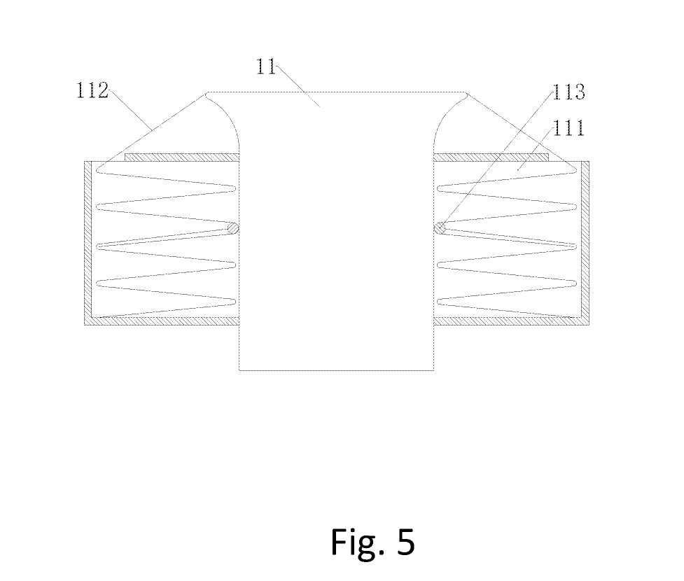

As shown in FIG. 5, the outside wall of the upper end of the upper sleeve 11 is provided with an annular box 111 and an umbrella cover 112. The umbrella cover 112 is folded into an annular shape and sleeved into the annular box 111. As shown in FIG. 4, the upper end of the umbrella cover 112 is sleeved at the opening of the upper end of the upper sleeve 11. In another example embodiment, the annular box 111 are integrated with the upper sleeve 11.

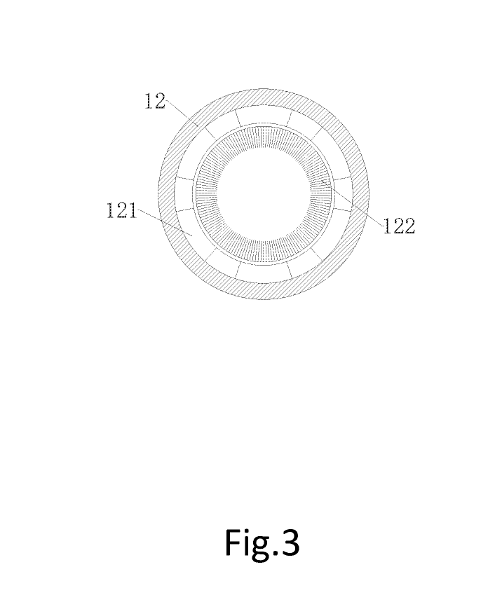

As shown in FIG. 3, the inside wall of the middle sleeve 12 is provided with an annular array consisting of a plurality of ultrasonic transducers 121. The ultrasonic transducers 121 are provided with fiber brushes 122. The ultrasonic transducers 121 generate ultrasonic wave to shake off the rainwater from the umbrella. Fiber brushes 122 are vibrated by the transducers 121 to clean the surface of the umbrella.

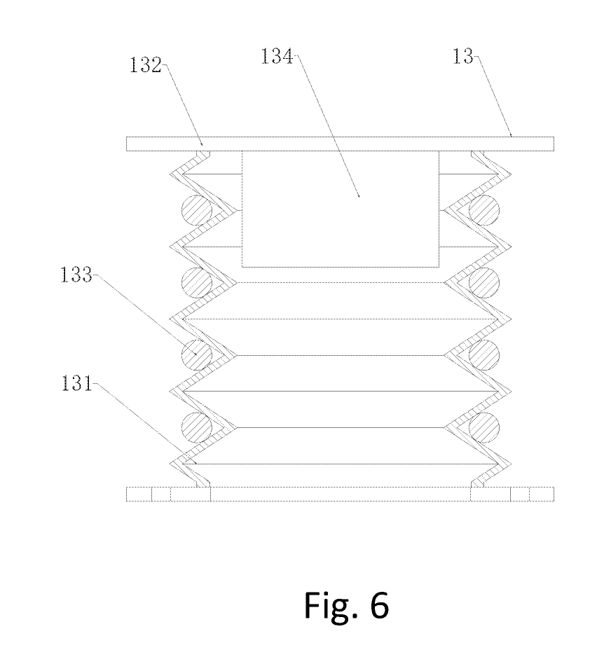

As shown in FIG. 6, the telescopic sleeve 13 includes a first corrugated telescopic tube 131, connecting flanges 132 positioned at two ends of the first corrugated telescopic tube 131, and a reset spring 133 positioned at the first corrugated telescopic tube 131. The connecting flanges 132 positioned at two ends of the first corrugated telescopic tube 131 connect to the middle sleeve 12 and the lower sleeve 14, respectively. Two ends of the reset spring 133 respectively connect to the connecting flanges 132 at two ends of the first corrugated telescopic tube 131. The top connecting flange 132 is provided with a water-absorbing mechanism 134. When the umbrella inserts into the sleeve 1, the first corrugated telescopic tube 131 elongates in accordance with the length of the umbrella. The first corrugated telescopic tube 131 retracts when the umbrella is pulled out.

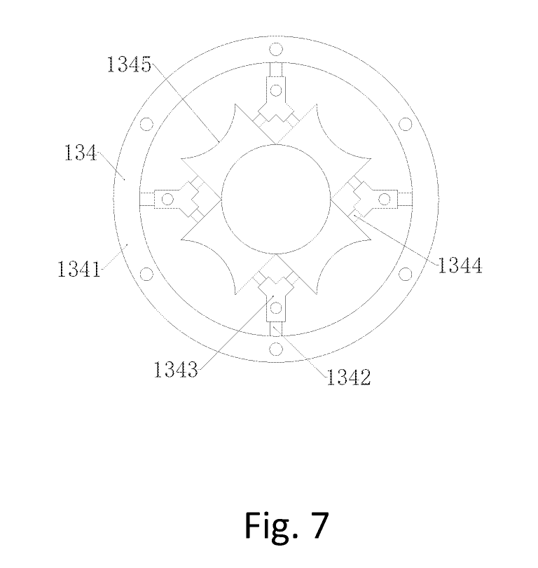

As shown in FIG. 7, the water-absorbing mechanism 134 includes a water-absorbing sleeve 1341 that extends to the openings of two ends of the inside of the first corrugated telescopic tube 131, a plurality of cam shafts 1342 circumferentially arranged in the inside wall of the water-absorbing sleeve 1341, a plurality of spindles 1344, a sponge 1345 arranged at the spindles 1344 and having a concave curved structure, a connecting element 1343 that connects the spindle 1344 and the cam shaft 1342. In another example embodiment, the sponge 1345 may be made of a plurality of round and flaky sponges stacked together. The round and flaky sponges may be stacked closely or positioned on the spindle 1344 with a certain distance with each other.

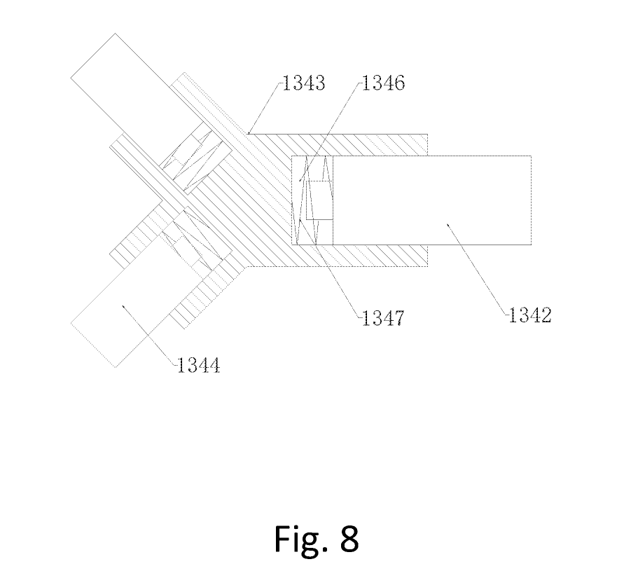

As shown in FIG. 8, the connecting ends of the spindle 1344 and the cam shaft 1342 respectively extend into an inner cavity 1346 positioned at the connecting element 1343, and are in contact with a third cushion spring 1347 in the inner cavity 1346. Such structure enables the water-absorbing mechanism 134 to have the ability of adapting to the different diameters of the umbrellas.

In an example embodiment, the connecting element is made of elastic material. The connecting ends of the spindle 1344 and the cam shaft 1342 respectively extend into an inner cavity 1346 positioned at the connecting element 1343. The third cushion 1347 is not provided in the inner cavity 1346. The elasticity of the connecting element is relied on to enable the water-absorbing mechanism 134 to have the ability of adapting to the different diameters of the umbrellas.

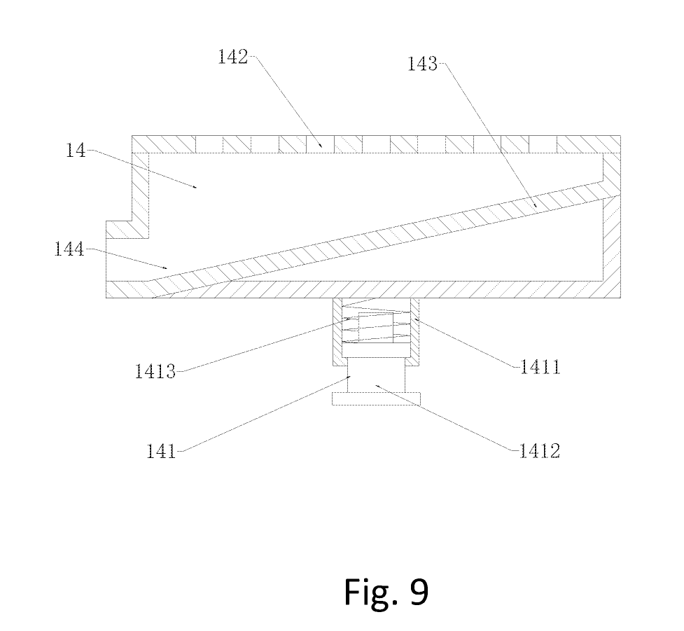

As shown in FIG. 9, the lower end of the lower sleeve 14 is provided with a cushion mechanism 141. The upper end of the lower sleeve 14 is provided with a screen 142. A deflector 143 used to guide rainwater towards a water outlet 144 is positioned inside the lower sleeve 14. This can avoid to keep the rainwater staying in the lower sleeve 14 for a long time, which affects the life of the lower sleeve or breed harmful substances.

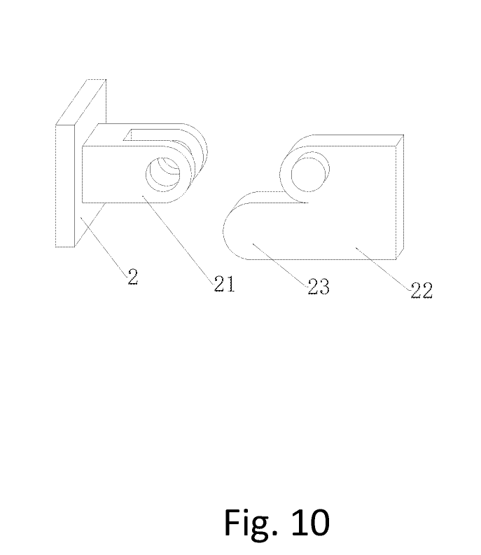

As shown in FIG. 10, the folding bracket 2 includes a fixed bracket 21 connected to the externals, and a movable bracket 22 hinged to the fixed bracket 21. The movable bracket 22 connects to the middle sleeve 12. The sleeve 1 can be folded so that the sleeve is put away when the sleeve is not used.

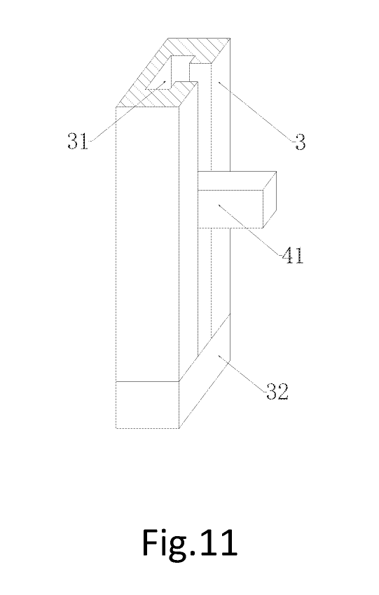

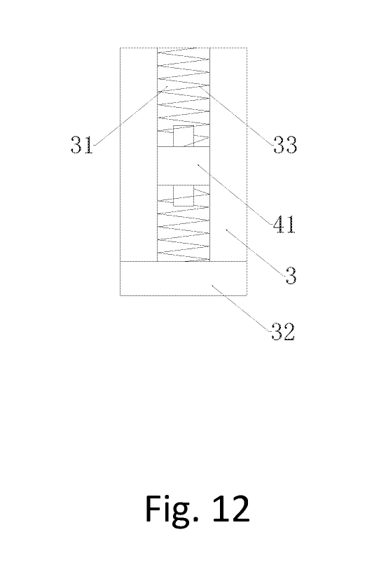

As shown in FIGS. 11 and 12, the sliding plate 3 is fixed with the externals. The sliding plate 3 is provided with a T-shaped chute 31. The T-shaped chute 31 is provided with two second cushion springs 33. Two ends of the T-shaped chute 31 are provided with blocks 32.

As shown in FIG. 1, the rain collector 4 includes a support plate 41 slidably connected with the T-shaped chute 31, a vacuum pump 42 positioned on the support plate 41, and a water box 43 connected with the vacuum pump 42. The vacuum pump 42 connects the water outlet 144 via a second corrugated telescopic tube 145.

In an example embodiment, a roller(s) that are in contact with the vertical wall are provided on the sliding plate 3. A hydraulic lever or a pneumatic lever is provided at the bottom of the sliding plate 3. The support plate 41 is fixedly connected to the sliding plate 3.

In an example embodiment as shown in FIG. 2, the upper end of the upper sleeve 11 is provided with outward revers. The inside of the upper end of the upper sleeve 11 is provided with an infrared switch used to monitor if there is an umbrella that inserts into the sleeve 1.

In an example embodiment as shown in FIG. 5, the upper end of the umbrella cover 112 is provided with an elastic belt 113. The elastic belt 113 at the upper end of the below umbrella cover in the annular box 111 is engaged with the middle portion of the above umbrella cover 112. The above umbrella cover and the below umbrella cover are folded together. In such way, when the above umbrella cover is taken out, the below umbrella cover 112 moves upward under the force of friction and sleeved at the opening of the upper sleeve 11.

In an example embodiment as shown in FIG. 9, the cushion mechanism 141 includes a cushion sleeve 1411 positioned at the lower sleeve 14, a first cushion spring 1411 positioned in the cushion sleeve 1411, and a cushion column 1412 extending into the cushion sleeve 1411 and being in contact with the first cushion spring 1413.

In an example embodiment as shown in FIG. 10, the movable bracket 22 has a projection 23 that is integrated with the movable bracket 22. The projection 23 is in contact with the fixed bracket 21.

In an example embodiment as shown in FIG. 1, the housing 45 covers the vacuum pump 42 and the water box 43, and connects with the support plate 41.

In an example embodiment as shown in FIG. 1, a micro controller 123 is positioned below the folding bracket 2. The micro controller 123 is electrically connected to the infrared switch and the ultrasonic transducers 121. The micro controller 123 is responsible for receiving and collecting the signals of the infrared switch, and controlling the work of the ultrasonic transducers 121 accordingly.

In an example embodiment as shown in FIG. 1, a press type switch 44 used to control the vacuum pump 42 is positioned above the housing 45. Two ends of the press type switch 44 are electrically connected to the vacuum pump 42 and the micro controller 43, respectively. The press type switch 44 and the cushion column 1412 are positioned on the same shaft. The vacuum pump 42 sucks the rainwater from the umbrella and the sleeve 1, and save the rainwater in the water box 43. In an example embodiment, the press type switch 44 is positioned at the bottom of the cushion column 1412. The press type switch 44 is pressed by contacting the cushion column 1412 with the housing 45 to turn on the vacuum pump.

The automatically clean and dry device via ultrasonic vacuum for intelligent household umbrellas of the invention includes a sleeve, a folding bracket, a sliding plate, and a rainwater collector. Two ends of the folding bracket connect to the sleeve and a fixed surface of the externals, respectively. The sleeve can be folded to save room when the sleeve is not used. Two ends of the sliding plate connect to the rainwater collector and a connecting surface of the externals, respectively. The rainwater collector can slide along the sliding plate to adapt to the length of the umbrella. By the combination of the ultrasonic wave and the brushes, the sleeve can shake off the rainwater from the umbrella and on other hand, the vibrated brushes clean the surface of the umbrella. The rainwater falls downstream and goes through the water-accumulating mechanism adapted to the diameter of the umbrella and the vacuum pump, such that the rainwater is collected into the water box. When the umbrella is pulled out, the umbrella cover on the sleeve automatically covers the umbrella. The device of the invention has advantages of having reasonable and simple structure, and various functions, being easy to use, safe and reliable, and not being easily damaged, etc. It effectively solves the problem regarding the fact that the existing dry devices for umbrellas easily damage the umbrellas.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An automatically clean and dry device via ultrasonic vacuum for intelligent household umbrellas, comprising: a sleeve 1, a folding bracket 2, a sliding plate 3, and a rainwater collector 4,
wherein the sleeve 1 includes an upper sleeve 11, a middle sleeve 12, a telescopic sleeve 13 and a lower sleeve 14 from the top to the bottom,
wherein the upper sleeve 11 and the middle sleeve 12 are sleeved, and are engaged with each other at the sleeve place; the outside wall of the upper end of the upper sleeve 11 is provided with an annular box 111 and an umbrella cover 112; the umbrella cover 112 is folded into an annular shape and sleeved into the annular box 111; the upper end of the umbrella cover 112 is sleeved at the opening of the upper end of the upper sleeve 11; the inside wall of the middle sleeve 12 is provided with an annular array consisting of a plurality of ultrasonic transducers 121; the ultrasonic transducers 121 are provided with fiber brushes 122,
wherein the telescopic sleeve 13 includes a first corrugated telescopic tube 131, connecting flanges 132 positioned at two ends of the first corrugated telescopic tube 131, and a reset spring 133 positioned at the first corrugated telescopic tube 131; the connecting flanges 132 positioned at two ends of the first corrugated telescopic tube 131 connect to the middle sleeve 12 and the lower sleeve 14, respectively; two ends of the reset spring 133 respectively connect to the connecting flanges 132 at two ends of the first corrugated telescopic tube 131,
wherein the top connecting flange 132 is provided with a water-absorbing mechanism 134; the water-absorbing mechanism 134 includes a water-absorbing sleeve 1341 that extends to the openings of two ends of the inside of the first corrugated telescopic tube 131, a plurality of cam shafts 1342 circumferentially arranged in the inside wall of the water-absorbing sleeve 1341, a plurality of spindles 1344, a sponge 1345 arranged at the spindles 1344 and having a concave curved structure, a connecting element 1343 that connects the spindle 1344 and the cam shaft 1342; the connecting ends of the spindle 1344 and the cam shaft 1342 respectively extend into an inner cavity 1346 positioned at the connecting element 1343, and are in contact with a third cushion spring 1347 in the inner cavity 1346,
wherein the lower end of the lower sleeve 14 is provided with a cushion mechanism 141; the upper end of the lower sleeve 14 is provided with a screen 142; a deflector 143 used to guide rainwater towards a water outlet 144 is positioned inside the lower sleeve 14,
wherein the folding bracket 2 includes a fixed bracket 21 connected to the externals, and a movable bracket 22 hinged to the fixed bracket 21; the movable bracket 22 connects to the middle sleeve 12,
wherein the sliding plate 3 is fixed with the externals; the sliding plate 3 is provided with a T-shaped chute 31; the T-shaped chute 31 is provided with two second cushion springs 33; two ends of the T-shaped chute 31 are provided with blocks 32,
wherein the rain collector 4 includes a support plate 41 slidably connected with the T-shaped chute 31, a vacuum pump 42 positioned on the support plate 41, and a water box 43 connected with the vacuum pump 42; the vacuum pump 42 connects the water outlet 144 via a second corrugated telescopic tube 145.

2. The automatically clean and dry device via ultrasonic vacuum for intelligent household umbrellas of claim 1, wherein the upper end of the upper sleeve 11 is provided with outward revers; the inside of the upper end of the upper sleeve 11 is provided with an infrared switch.

3. The automatically clean and dry device via ultrasonic vacuum for intelligent household umbrellas of claim 1, wherein the upper end of the umbrella cover 112 is provided with an elastic belt 113; the elastic belt 113 at the upper end of the below umbrella cover in the annular box 111 is engaged with the middle portion of the above umbrella cover 112; the above umbrella cover and the below umbrella cover are folded together.

4. The automatically clean and dry device via ultrasonic vacuum for intelligent household umbrellas of claim 1, wherein the cushion mechanism 141 includes a cushion sleeve 1411 positioned at the lower sleeve 14, a first cushion spring 1411 positioned in the cushion sleeve 1411, and a cushion column 1412 extending into the cushion sleeve 1411 and being in contact with the first cushion spring 1413.

5. The automatically clean and dry device via ultrasonic vacuum for intelligent household umbrellas of claim 1, wherein the movable bracket 22 has a projection 23 that is integrated with the movable bracket 22; the projection 23 is in contact with the fixed bracket 21.

6. The automatically clean and dry device via ultrasonic vacuum for intelligent household umbrellas of claim 1, wherein the housing 45 covers the vacuum pump 42 and the water box 43, and connects with the support plate 41.

7. The automatically clean and dry device via ultrasonic vacuum for intelligent household umbrellas of claim 1, wherein a micro controller 123 is positioned below the folding bracket 2; the micro controller 123 is electrically connected to the infrared switch and the ultrasonic transducers 121.

8. The automatically clean and dry device via ultrasonic vacuum for intelligent household umbrellas of claim 1, wherein a press type switch 44 used to control the vacuum pump 42 is positioned above the housing 45; two ends of the press type switch 44 are electrically connected to the vacuum pump 42 and the micro controller 43, respectively; the press type switch 44 and the cushion column 1412 are positioned on the same shaft.
